(19) United States
(12) Patent Application Publication
(10) Pub. No.: US 2016/0104393 A1
(43) Pub. Date: Apr. 14, 2016

(54) EMBEDDED SYSTEM AND METHOD FOR NEEDLE TRACKING DURING MEDICAL TRAINING AND TESTING

(71) Applicant: SonoSim, Inc., Santa Monica, CA (US)

(72) Inventors: Eric Savitsky, Malibu, CA (US); Gabriele Nataneli, Los Angeles, CA (US); Kresimir Petrinec, Los Angeles, CA (US); Dan Katz, Encino, CA (US)

(73) Assignee: SonoSim, Inc.

(21) Appl. No.: 14/882,331

(22) Filed: Oct. 13, 2015

Related U.S. Application Data
(60) Provisional application No. 62/063,314, filed on Oct. 13, 2014.

(51) Int. Cl. G09B 23/28

(52) U.S. Cl. CPC G09B 23/285

(57) ABSTRACT

This invention describes a system and method for simulating a needle-based medical procedure for purposes of education and training. The described invention has a variety of medical training and assessment applications and can integrate and enhance a variety of existing medical simulation and assessment processes and technologies. The described device is designed to operate in the form of a needle and syringe, and will measure the orientation and penetration depth of the needle and contains all the necessary hardware to transmit this information to a remote installation that can process and visualize the data within a computer-based training device.

### CROSS-REFERENCES TO RELATED APPLICATIONS

This application claims the benefit of U.S. Provisional Patent Application No. 62/063,314 filed Oct. 13, 2014, which is incorporated here in its entirety by this reference.

### BACKGROUND OF THE INVENTION

1. Field of the Invention

The present invention relates to ultrasound training and testing systems and has broader applications in alternative needle-based training and testing scenarios.

2. Description of the Related Art

Medical procedures often involve needle-based procedures, such as when an intravenous catheter is placed in a patient to administer medications. Training medical personnel on how to perform such procedures has relied on practicing on human volunteers, cadavers, and mannequin-based simulators. Advances in computer-based education have enabled using virtual patients as virtual training subjects. For example, computer-based simulation using a virtual patient to train individuals on how to perform ultrasonography has been described by Savitsky (US 2012/0237913). A limitation of such systems has been simulating the needle-based component of ultrasound-guided procedures. This and other computer-based medical training systems rely upon a virtual body and virtual needle. Virtual needle movement is controlled by computer keypads or by information gathered using motion-tracking technologies. Alternative systems use mechanical or alternative external motion-tracking tracking systems to track needle motion and transfer that information into a broader simulated training system (US 2011/0200977, US 2012/0219937, EP 1103223). Such devices rely upon motion tracking technologies that are external to the needle and have high associated cost and have a large physical footprint. A low-cost, small physical footprint system and method for tracking a needle in the context of a medical procedure is required. This system and method may also reliably and seamlessly communicate tracked motion data into a broader medical training context and system. To date, there are no described systems that satisfy these criteria. The lack of this resource is hindering the ability to train medical personnel on how to perform a variety of needle-based procedures, such as ultrasound-guided simulation.

This described system and method for simulating a needle-based intervention has many applications. One specific domain is to extend the fidelity of ultrasound training. This invention can expand the capabilities of existing ultrasound training technologies to include ultrasound-guided or image-guided needle-based interventions. Advantages of ultrasound-guided procedures include reducing medical complications, decreasing the number of needle sticks, and reducing patient discomfort. This skill set is heavily operator-dependent and training is required to acquire this proficiency. Once an operator is trained, he or she can use ultrasound to identify an anatomical target, advance a needle towards the target, watch the needle tip as it advances, and ensure that the needle tip penetrate its target and ensure that it does not cause iatrogenic injury (e.g., hemorrhage, pneumothorax) en route.

While the benefits of employing ultrasound imaging for guiding needle procedures are obvious, learning the required skills is very difficult. Ultrasound images are hard to interpret, it is hard to track the advancement of the needle within an ultrasound image, and it is particularly hard to achieve the necessary hand-eye coordination to control both a needle and an ultrasound transducer simultaneously without error. This invention introduces a small physical footprint, precise, and low-cost solution that allows the learner to acquire hands-on training with ultrasound-guided procedures in a simulated environment, while performing the same types of physical motions and manipulations that one would perform with a real-needle, a real ultrasound machine, and a real patient.

### SUMMARY OF THE INVENTION

One embodiment of the present invention comprises a handheld device shaped like a medical syringe, which we will refer herein as a needle controller. This needle controller consists of a cylindrical body, which the user holds in the hand, and houses all the embedded electronics, mechanical components, and an elongated retractable needle. The retractable mechanism emulates the way a needle penetrates inside the body, but it does so by retracting inside the cylindrical enclosure instead of piercing and penetrating inside tissue or a medical phantom. In the present application, we will refer to the length of the needle that retracts inside the enclosure as the penetration depth. The needle controller in this embodiment is capable of:
(a) Measuring two rotational degrees-of-freedom;
(b) Measuring the penetration depth of the needle; and
(c) Transmitting all the measurements to a remote device that hosts the simulation software

The needle controller also hosts a microcontroller unit (MCU) to gather all the measurements from the sensing units and relay them to the transmission unit. For wireless communication, the apparatus may also contain a power unit, such as a rechargeable battery, to supply power to the electronics and the wireless transmission unit.

### BRIEF DESCRIPTION OF THE DRAWINGS

FIG. 1 is a diagram of a syringe in keeping with one embodiment of the present invention.

FIG. 2A is a diagram of a retractable needle 10 in keeping with one embodiment of the present invention comprising an optical sensor 54.

FIG. 2B is the retractable needle of FIG. 2A with the needle partially retracted.

FIG. 3 is a diagram of one embodiment of the retractable needle 10 comprising a pressure sensor 40.

FIG. 4 is a diagram of an embodiment of the retractable needle 10 comprising an optical displacement tracker 60.

FIG. 5 is a diagram of one embodiment of the retractable needle 10 comprising a resistance controller 70 for force feedback.

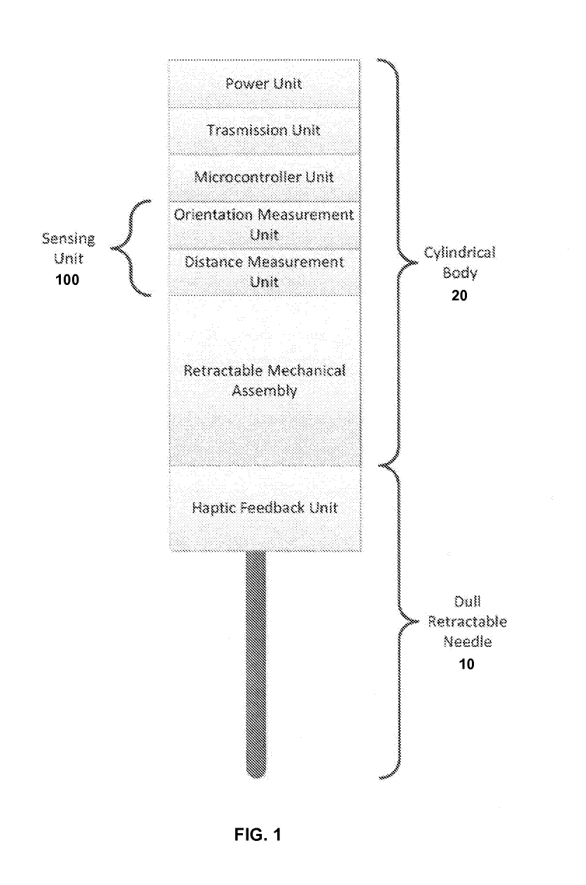

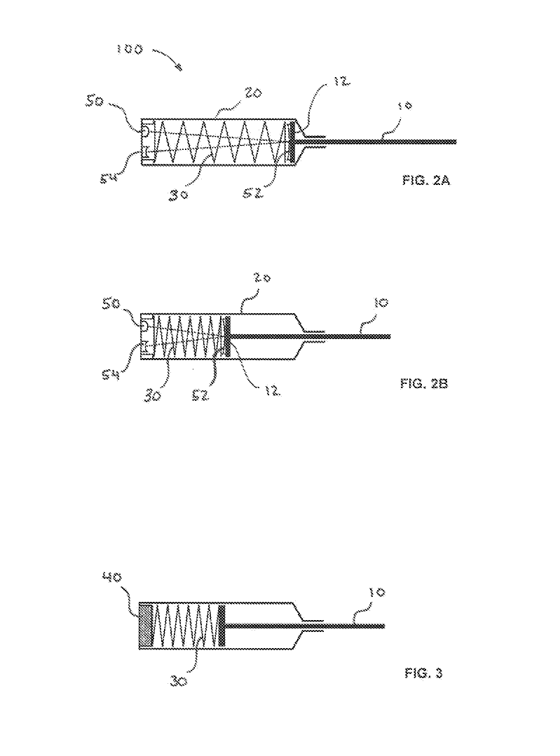

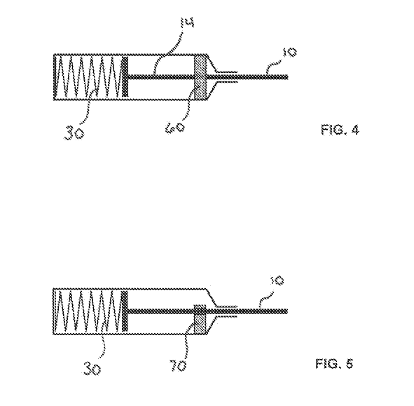

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

### Retractable Mechanical Assembly

An embodiment of the described invention has a small physical footprint and represents a precise and low-cost solution that allows a learner to acquire hands-on training with ultrasound-guided procedures in a simulated environment, while performing the same types of physical motions and manipulations that one would perform with a real-needle, a real ultrasound machine, and a real patient.

The retractable mechanical action of the device allows the needle 10 to retract inside the cylindrical body 20 when the device is pushed downward, and restore its original length when no force is applied to it. A simple design that achieves this purpose is to anchor the base 12 of the needle to the cylindrical body with a spring 30. The same action can be achieved with a compression or an extension spring. The pitch, length, and material of the spring 30 should be chosen such that the force required to displace the retractable needle 10 is equivalent to the force required to insert a real medical needle in a patient, which amounts to roughly 100 grams-force or about 1 Newton.

Traditional springs exert a restoring force that is linear in the amount of displacement. While this property can be directly exploited as a way to measure the penetration depth of the needle (refer to section on pressure sensor), in one embodiment, it is generally undesirable as the resistance of soft tissue against a needle is fairly constant. To obviate this fact, the implementer may choose conical springs or rolled springs that are designed to exert constant force at all values of displacements. Alternatively, the same effect can be achieved with a pneumatic mechanism similar to a real medical syringe. If the implementer desires to model the mechanics of a real needle more accurately, he or she may choose to design a special non-linear spring that exerts high resistance for very small displacements and then proceeds with roughly constant resistance for larger displacements until the needle is fully retracted. The latter design emulates the fact that a real needle normally must be pressed against the skin with a larger force initially to pierce the tissue, and then it progresses with reduced resistance once the sharp end is inside the patient's body.

### Distance Measurement Unit

The purpose of the distance measurement unit 100 is to measure the penetration depth of the retractable needle 10 accurately. The distance measurement unit 100 can be built in a variety of ways around different operating principles that are described in the following paragraphs. Importantly, all of the described methods can be delivered with small physical footprint components that can be embedded within the physical shell of the simulated needle 10.

### Linear Potentiometer

A linear potentiometer uses a resistive component to measure distance on a linear track. Linear potentiometers are commercially available in two basic forms:

1. A cylinder with a piston that slides in and out;

2. A single open track that senses the position of a single pressure point.

### String Potentiometer

A string potentiometer is composed a main rectangular or cylindrical housing that stores a long coiled spring 30 wound around an internal rotating spool. The device can measure the length of the string that is pulled out and possesses a spring action that maintains tension and causes the string to retract when it is released.

### Pressure Sensor

If the retractable mechanical assembly is built using a linear spring or a non-linear spring with a known force profile, a user can correlate the restoring force exerted by the spring 30 to the penetration depth of the needle 10. To do so, the user must place a pressure sensor 40 inside the needle assembly that receives and measures the restoring force exerted by the spring 30. A variety of pressure sensors are available commercially that can serve this purpose. Simple resistive strain gauges can be adequate for this purpose, but the implementer may choose more sophisticated pressure sensors, such as resistive load cells, or capacitive pressure pads for increased accuracy and repeatability. Alternatively, the pressure pad can be separated from needle controller and placed outside, whereas the user will press the dull needle 10 against the pad, and the pad will contain the necessary hardware to communicate the reading of pressure to the installation running the training simulator software.

### Optical Time-of-Flight Sensor

Time-of-flight distance measurement units, typically shine a controlled laser beam against a target 52 and measure the time it takes for the light to bounce back to the unit using a photo detector 54. Since light travels at a constant speed, measuring the time it takes for the laser beam to hit the target and bounce back can be used to determine the distance between the optical assembly 50 and the target 52. Optical time-of-flight sensors can be very accurate, but they also tend to be fairly expensive.

### Optical Light Intensity Sensor

An optical light intensity sensor consists of an assembly that combines one or more light sources 50 (e.g., LED lights) and a light detector 54 (e.g., a photo resistor, photo transistor, or other similar component) placed on one end of the cylindrical body 20, and a reflector 52, such as a flat or curved mirror 52 placed at the other end and attached to the retractable mechanical assembly. Changing the penetration depth of the retractable mechanical assembly changes the distance between the mirror 52 and the light source 50 and therefore also varies the amount of light that is measured by the light detector 54. If care is taken to ensure that the internal walls of the cylindrical body 20 are opaque for the chosen wavelength of light, this simple assembly can be used to accurately measure the penetration depth.

### Optical Displacement Tracker

A small camera 60 is placed on the side of the cylindrical body 20 looking inside, and the retractable mechanical assembly is extended with a cylindrical shaft 14 that slides within the cylindrical body 20 of the needle controller. If the internal cylindrical shaft 14 is detailed with well-defined markings, the camera 60 can track the motion of the markings as a way to measure the distance travelled by the retractable mechanical assembly up and down. Alternatively, the implementer may use a simple light intensity sensor to measure the alternation of markings following the same operating principle of linear or rotary encoders.

### Ultrasonic Distance Sensor

As a cheaper alternative to an optical time-of-flight sensor, the implementer may employ an ultrasonic distance sensor that uses a similar operating principle, but measures the time of flight of acoustic ultrasound waves instead of light.

### Orientation Measurement Unit

The orientation measurement unit measures the orientation of the needle controller with respect to the gravity vector. Although a three-dimensional orientation is typically expressed with three distinct degrees-of-freedom, for this application only two degrees-of-freedom are sufficient, since the needle controller is radially symmetric and the rotation of the device around its long axis does not provide any useful information for the application described in this embodiment. In one preferred embodiment, the orientation is measured using an Inertial Measurements Unit (IMU) comprising a MEMS accelerometer unit, a MEMS gyroscope unit, and an optional MEMS magnetometer unit. Such devices are widely available and well known to those skilled in the art. The advantage of an IMU is the small form factor and that it does not require a separate device to act as an external reference. However, the same goal can be achieved using an optical system with one or more external cameras, or an electromagnetic system with an external magnetic reference typically used for six degrees-of-freedom measurements.

### Haptic Feedback Unit

An optional haptic feedback unit may consist of a controlled mechanical actuator that applies resistance to the retractable needle, makes the unit vibrate, or locks the needle in place. The purpose of this unit is to emulate the physical resistance of various anatomical tissues to the advancement of the needle 10, hard collisions with bones, and other dynamics of a living body responding to a needle procedure.

### Microcontroller Unit

In a preferred embodiment the microcontroller unit gathers raw data from the orientation measurement unit and the distance measurement unit, performs the necessary computations to determine the correct value of orientation and penetration depth of the needle controller, and relays these values to the transmission unit. Alternatively, if the implementer desires to use a cheaper component, the responsibility microcontroller unit can be restricted to only gather raw data from the sensors without performing any additional computations, and relay this data with time stamps to the transmission unit. In that case, the separate computer unit that runs the training simulator software will be also responsible of performing the necessary computations to determine the values of orientation and penetration depth from the raw sensor data.

In another embodiment, an internal microcontroller unit is responsible for gathering raw sensor data, and an external microcontroller unit is responsible for performing computations and relay the computed values through the transmission unit.

### Transmission Unit

The purpose of the transmission unit is to gather data from the microcontroller unit and send it to the separate computer unit running the training simulator software. In a preferred embodiment the transmission unit is a wireless component that can send data to the computer unit over the air. The transmission unit can be built using any of several available industry standards such as:
a) Bluetooth;
b) Bluetooth Low Energy (also known as Bluetooth 4.0 or Bluetooth Smart); and
c) Wi-Fi.

Alternatively, the implementer may choose to support multiple protocols simultaneously, using for instance dual-mode Bluetooth chips, or separate components for supporting Bluetooth and Wi-Fi at the same time.

A wireless solution has the advantage of not requiring a wire between the needle controller and the computer unit, but has the disadvantage of requiring a separate power unit and placing additional engineering constraints on the power consumption of the electrical components. In this regard, the implementer may choose to simplify the design with a wired transmission unit built around industry standards such as USB, Thunderbolt, or FireWire.

### Power Unit

If the transmission unit is built to work wirelessly, then a separate power unit is required to supply power to the electronic components and manage the resupply of power. The simplest solution for the power unit is to use a coin battery or other type of single-use battery that is small enough to fit within the housing of the needle controller. If a single-use battery is employed, then the housing may be designed in a way to allow the needle controller to be opened and the battery replaced. Alternatively, the implementer may choose to employ a rechargeable battery. In turn, a rechargeable battery may need additional electronics for allowing the battery to be recharged for instance using a mini USB cable, and to monitor the remaining charge.

Usage of the Needle Controller with a Training Simulator

In a preferred embodiment the ultrasound-guided needle-based procedure-training simulator is composed of:
a) A handheld ultrasound probe controller;
b) A needle controller; and
c) The training simulator software.

### Handheld Ultrasound Probe Controller

The handheld ultrasound probe controller is a device shaped like a real ultrasound transducer that can relay at least three rotational degrees-of-freedom to the computer platform running the simulation software. Such devices can be built using several operating principle and are available as part of commercial ultrasound training simulators.

### Training Simulator Software

The training simulator is a software application that runs on a regular laptop, desktop, or mobile computer and at minimum is expected to allow the user to:
a) Select a medical case from a list;
b) Control the orientation of a virtual ultrasound probe on screen by manipulating the probe controller;
c) Display an image representing the anatomy that a user would see by placing a real ultrasound probe on a real patient at the same orientation;
d) Control the orientation and penetration depth of a syringe on screen by manipulating the needle controller; and
e) Show the advancement of the needle and the interaction between the needle and soft tissue in the ultrasound view, mimicking what a practitioner would see on a real ultrasound machine when using a real syringe on a real patient.

### Basic Usage

1. The user ensures that the ultrasound probe controller and the needle controller are properly paired with the software;
2. The user selects a medical case in the software using a graphical user interface;
3. The software presents the user with a visual representation of human subject with a needle and an ultrasound probe placed on a desired region of the body, where the procedure is to be performed;
4. The user manipulates the ultrasound probe controller to obtain an optimal view of the anatomy where the needle procedure will be performed;
5. The user carefully changes the orientation of the needle controller to define the incident angle of the syringe using the ultrasound view as guidance;
6. The user carefully changes the penetration depth of the needle controller, and monitors the advancement of the needle in the simulated ultrasound view on screen; and
7. Using the simulated ultrasound view on screen as guidance, the user performs the necessary adjustments to the orientation and penetration depth of the needle controller to ensure that the sharp end of the needle reaches the designated target in the simulation.

While the present invention has been described with regards to particular embodiments, it is recognized that additional variations of the present invention may be devised without departing from the inventive concept.

What is claimed is:

1. A system for simulating a needle-based medical procedure for purposes of education and training comprising a device for measuring the excursion of a needle.

2. The system of claim 1 wherein the device for measuring the excursion of a needle comprises a linear potentiometer.

3. The system of claim 1 wherein the device for measuring the excursion of a needle comprises a string potentiometer.

4. The system of claim 1 wherein the device for measuring the excursion of a needle comprises a pressure sensor.

5. The system of claim 1 wherein the device for measuring the excursion of a needle comprises a light emitter for emitting a beam or pulse of light and a timed light detector for detecting the time-of-flight of the light emitted from the light emitter.

6. The system of claim 1 wherein the device for measuring the excursion of a needle comprises a light emitter for emitting a beam or pulse of light and a light detector for detecting the intensity of the light emitted from the light emitter.

7. The system of claim 1 wherein the device for measuring the excursion of a needle comprises a shaft with markings and one or more optical sensors configured to detect the one or more markings.

8. The system of claim 1 wherein the device for measuring the excursion of a needle comprises an ultrasonic distance sensor.

9. A method for simulating a needle-based medical procedure for purposes of education and training, comprising measuring the excursion of a needle.

10. The method of claim 9 wherein the step of measuring the excursion of a needle comprises employing a linear potentiometer.

11. The method of claim 9 wherein the step of measuring the excursion of a needle comprises employing a string potentiometer.

12. The method of claim 9 wherein the step of measuring the excursion of a needle comprises employing a pressure sensor.

13. The method of claim 9 wherein the step of measuring the excursion of a needle comprises employing a light emitter for emitting a beam or pulse of light and a timed light detector for detecting the time-of-flight of the light emitted from the light emitter.

14. The method of claim 9 wherein the step of measuring the excursion of a needle comprises employing a light emitter for emitting a beam or pulse of light and a light detector for detecting the intensity of the light emitted from the light emitter.

15. The method of claim 9 wherein the step of measuring the excursion of a needle comprises employing a shaft with markings and one or more optical sensors configured to detect the one or more markings.

16. The method of claim 9 wherein the device for measuring the excursion of a needle comprises an ultrasonic distance sensor.

17. A method for simulating a needle-based medical procedure for purposes of education and training, comprising controlling needle resistance.

18. The method of claim 17 wherein the step of controlling needle resistance comprises employing a linear potentiometer.

19. The method of claim 17 wherein the step of controlling needle resistance comprises employing a string potentiometer.

20. The method of claim 17 wherein the step of controlling needle resistance comprises employing a pressure sensor.

21. The method of claim 17 wherein the step of controlling needle resistance comprises employing a light emitter for emitting a beam or pulse of light and a timed light detector for detecting the time-of-flight of the light emitted from the light emitter.

22. The method of claim 17 wherein the step of controlling needle resistance comprises employing a light emitter for emitting a beam or pulse of light and a light detector for detecting the intensity of the light emitted from the light emitter.

23. The method of claim 17 wherein the step of controlling needle resistance comprises employing a shaft with markings and one or more optical sensors configured to detect the one or more markings.

24. The method of claim 17 wherein the device for controlling needle resistance comprises an ultrasonic distance sensor.
